(19) United States
(12) Patent Application Publication
(10) Pub. No.: US 2025/0307695 A1
(43) Pub. Date: Oct. 2, 2025

(54) TIME SERIES ANOMALY DETECTION USING AUTOMATED MACHINE LEARNING FRAMEWORK

(71) Applicant: Snowflake Inc., Bozeman, MT (US)

(72) Inventors: Paritosh Aggarwal, San Carlos, CA (US); Boxin Jiang, Sunnyvale, CA (US); Kyle Duncan Schmaus, San Francisco, CA (US); Boyu Wang, Redwood City, CA (US); Jiayao Wang, Bellevue, WA (US)

(21) Appl. No.: 18/622,517

(22) Filed: Mar. 29, 2024

(51) Int. Cl. G06N 20/00

(52) U.S. Cl. CPC G06N 20/00

(57) ABSTRACT

Disclosed are techniques for anomaly detection in time series data using an ML model. An untrained time series forecasting machine learning (ML) model may be provided as part of a class that includes an anomaly detection function, a features module, and a target transform module. In response to the class being invoked, an instance of the time series forecasting ML model may be trained using training time series data specified in the invocation of the class. The trained instance of the forecasting ML model may be persisted in an anomaly detection object along with instances of the anomaly detection function, the features module, and the target transform module. In response to receiving a call to the anomaly detection object, performing anomaly detection on time series data specified in the call using at least the trained instance of the forecasting ML model and the instance of the anomaly detection function.

### TECHNICAL FIELD

Aspects of the present disclosure relate to time series analysis, and more particularly, to detection of anomalies within time series data using a machine learning (ML) model.

### BACKGROUND

Time-series analysis often refers to a variety of statistical modeling techniques including trend analysis, seasonality/cyclicality analysis, and anomaly detection. Predictions based on time-series analysis are extremely common and used across a variety of industries. For example, such predictions are used to predict values that change over time including weather patterns that can impact a range of other activities and sales that impact revenue forecasts, stock price performance, and inventory stocking requirements. In addition, time series analysis can be used in medicine to establish baselines for heart or brain function and in economics to predict interest rates.

Time-series predictions are built by complex statistical models that analyze historical data. There are many different types of time series models (e.g., statistical models such as ARIMA, exponential smoothing, tree-based machine learning algorithms, and modern deep learning transformers). All models have multiple parameters on which they can be built. Modern data scientists leverage machine learning (ML) techniques to find the best model and set of input parameters for the prediction they are working on.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system, in accordance with some embodiments of the present disclosure.

FIG. 2 is a block diagram that illustrates an example anomaly detection module, in accordance with some embodiments of the present disclosure.

FIG. 3 is a block diagram illustrating the creation of an anomaly detection object that includes a trained forecasting ML model, in accordance with some embodiments of the present disclosure.

FIG. 4 illustrates training time series data used to train the forecasting ML model of FIG. 3, in accordance with some embodiments of the present disclosure.

FIG. 5 is a block diagram illustrating the training process of the forecasting ML model of FIG. 3, in accordance with some embodiments of the present disclosure.

FIG. 6 is a block diagram illustrating execution of the anomaly detection object of FIG. 3 to detect anomalies in time series data, in accordance with some embodiments of the present disclosure.

FIG. 7 illustrates the result of the anomaly detection process of FIG. 6, in accordance with some embodiments of the present disclosure.

FIG. 8 is a flow diagram of a method for detecting anomalies in time series data using an ML model, in accordance with some embodiments of the present disclosure.

FIG. 9 is a block diagram of an example computing device that may perform one or more of the operations described herein, in accordance with some embodiments of the present disclosure.

### DETAILED DESCRIPTION

Time series forecasting is a common task in time series analysis and is one of the most commonly utilized features by data analysts. However, outliers (data points that deviate from the expected range) in a user's time series data can have an outsized impact on the statistics derived from the user's data and on machine learning models that are trained using the data. Identifying and removing outliers can help improve the quality of time-series analysis and can also assist in identifying the origins of problems or deviations in processes when there is no obvious cause. For example, outliers can be used to determine when a problem starts occurring with a data logging pipeline or identify the days when compute costs are higher than expected.

Often, databases or data exchanges may only provide very basic anomaly detection functionality (e.g., using statistical models) and in many cases users of a database or data exchange must write/code their own anomaly detection functions.

Embodiments of the present disclosure provide techniques for anomaly detection in time series data using an ML model framework. An untrained time series forecasting machine learning (ML) model may be provided as part of a class that includes an anomaly detection function, a preprocessing module, a features module, and a target transform module. In response to the class being invoked, an instance of the time series forecasting ML model may be trained using time series data specified in the invocation of the class. The trained instance of the forecasting ML model may be persisted in an anomaly detection object along with instances of the anomaly detection function, the preprocessing module, the features module, and the target transform module. In response to receiving a call to the anomaly detection object, anomaly detection may be performed on time series data specified in the call using at least the trained instance of the forecasting ML model and the instance of the anomaly detection function.

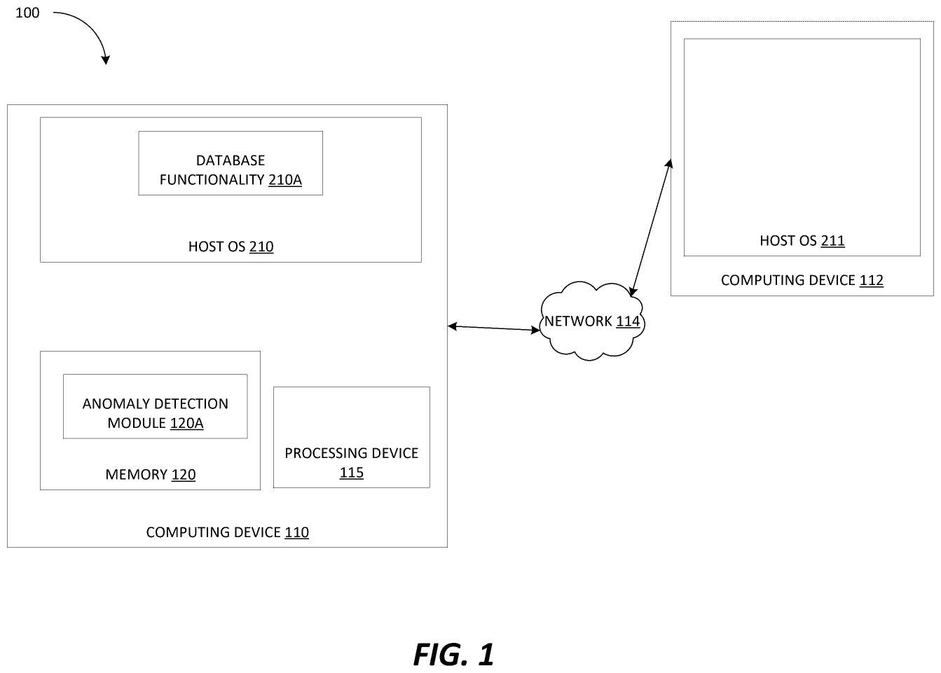

FIG. 1 is a block diagram that illustrates an example system 100. As illustrated in FIG. 1, the system 100 includes a computing device 110, and a plurality of computing device 112. The computing devices 110 and 112 may be coupled to each other (e.g., may be operatively coupled, communicatively coupled, may communicate data/messages with each other) via network 114. Network 114 may be a public network (e.g., the internet), a private network (e.g., a local area network (LAN) or wide area network (WAN)), or a combination thereof. In one embodiment, network 114 may include a wired or a wireless infrastructure, which may be provided by one or more wireless communications systems, such as a WiFi™ hotspot connected with the network 114 and/or a wireless carrier system that can be implemented using various data processing equipment, communication towers (e.g. cell towers), etc. In some embodiments, the network 114 may be an L3 network. The network 114 may carry communications (e.g., data, message, packets, frames, etc.) between computing device 110 and computing device 112. Each computing device 110 and 112 may include hardware such as processing device 115 (e.g., processors, central processing units (CPUs)), memory 120 (e.g., random access memory 120 (e.g., RAM)), storage devices (e.g., hard-disk drive (HDD), solid-state drive (SSD), etc.—not shown), and other hardware devices (e.g., sound card, video card, etc.—not shown). In some embodiments, memory 120 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 120 may be configured for long-term storage of data and may retain data between power on/off cycles of the computing device 110. Each computing device may comprise any suitable type of computing device or machine that has a programmable processor including, for example, server computers, desktop computers, laptop computers, tablet computers, smartphones, set-top boxes, etc. In some examples, each of the computing devices 110 and 112 may comprise a single machine or may include multiple interconnected machines (e.g., multiple servers configured in a cluster). The computing devices 110 and 112 may be implemented by a common entity/organization or may be implemented by different entities/organizations. For example, computing device 110 may be operated by a first company/corporation and one or more computing device 112 may be operated by a second company/corporation. Each of computing device 110 and computing device 112 may execute or include an operating system (OS) such as host OS 210 and host OS 211 respectively, as discussed in more detail below. The host OS of a computing device 110 and 112 may manage the execution of other components (e.g., software, applications, etc.) and/or may manage access to the hardware (e.g., processors, memory, storage devices etc.) of the computing device. In some embodiments, each of computing device 110 and computing device 112 may comprise a database platform (or part of a database platform) or a deployment of a data exchange. As shown in FIG. 1, the memory 120 may include an anomaly detection module 120A which may be executed by the processing device 115 in order to perform some or all of the functions described herein.

The host OS 210 may include database functionality 210A, which may provide the basic functions of a database/data exchange including command line functionality for command/query input, query optimization, data access/sharing, and role-based access control, among other functionality.

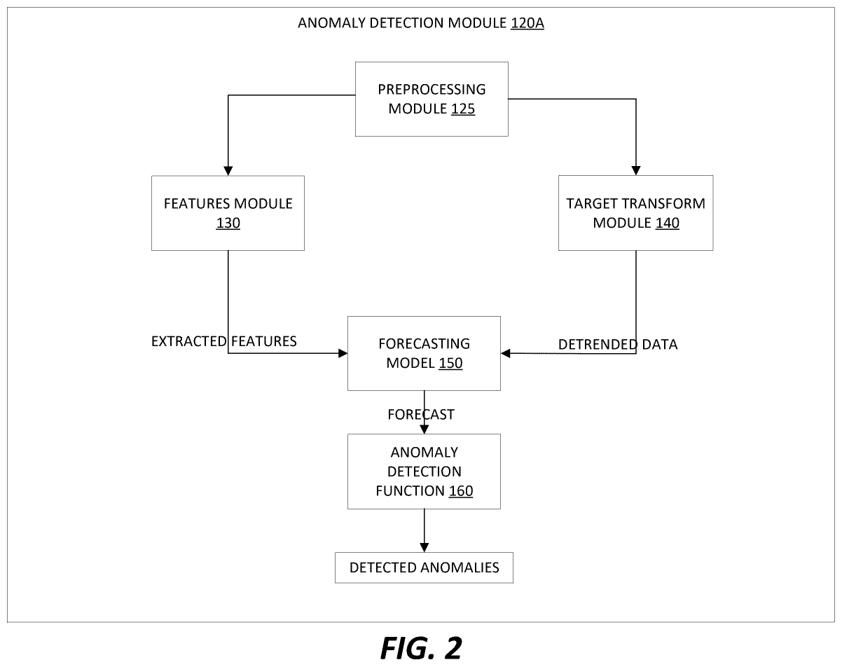

FIG. 2 illustrates an anomaly detection module 120A in accordance with some embodiments of the present disclosure. The anomaly detection module 120A may comprise five primary components, a preprocessing module 125, a features module 130, a target transform module 140, a forecasting model 150, and an anomaly detection function 160. The preprocessing module 125 may perform typing validation to check whether input time series data, including timestamp data, is within a supported range and to ensure that exogenous features do not change types. The preprocessing module 125 may also perform frequency inference on input time series data to infer the sampling frequency of the input time series data from the user provided timestamps. The target transform module 140 may determine whether input time series data has a trend and apply a target transform (such as a differencing transform) to detrend the input time series data. The features module 130 may capture seasonality features of the input time series data. The forecasting model 150 may comprise any appropriate ML model. For example, the forecasting model 150 may comprise a parallel tree boosting (also known as gradient boosted decision tree (GBDT), or gradient boosting machine (GBM)) model that solves many data science problems in a fast and accurate way. Unlike most traditional statistical time series algorithm implementations, GBDTs support the use of exogenous inputs and are both accurate and robust on a wide range of datasets. In other examples, the forecasting model 150 may comprise a statistical model or a deep learning method (including but not limited to so called “transformer” methods). Anomaly detection in time series data is closely related to time series forecasting. The forecasting model 150 may use the captured seasonality features and the detrended time series data to produce a forecast for the same time period as the actual data a user wishes to check for anomalies, and then the anomaly detection function 160 may compare the actual data to the forecast to identify outliers. The forecasting model 150 may be trained using a mean absolute error objective function to reduce the impact of outliers as discussed in further detail herein.

The anomaly detection techniques described herein may be applied to either single-series or multi-series data. For example, if a user's data comprises sales data for multiple stores, each store's sales can be checked separately by a single model based on the store identifier. An anomaly can be broadly categorized into three categories: point anomalies, contextual anomalies and collective anomalies. A tuple in a dataset is said to be a point anomaly if it is far off from the rest of the data. An observation is a contextual anomaly if it is an anomaly because of the context of the observation. An anomaly identified based on a set of data instances may be considered a collective anomaly.

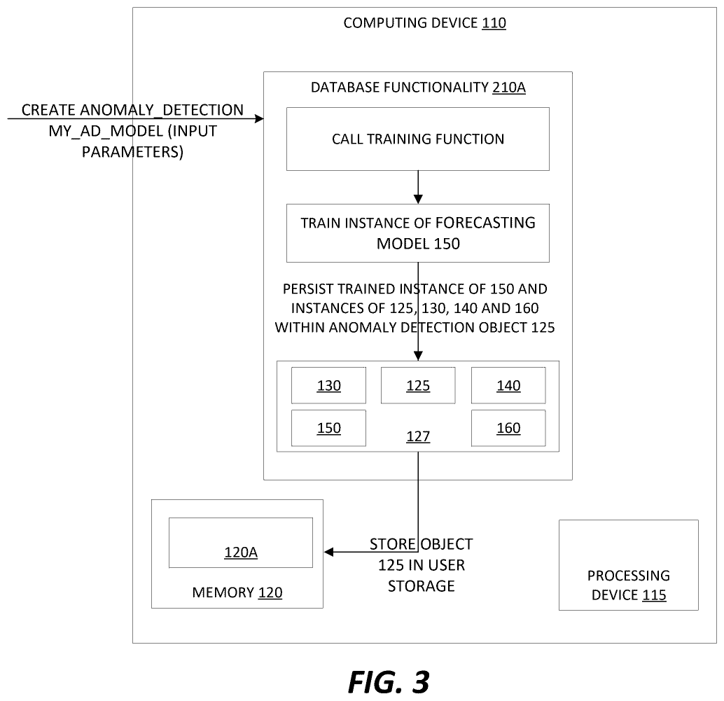

Referring also to FIG. 3, the database functionality 210A may provide the anomaly detection module 120A as a class (referred to as e.g., ANOMALY_DETECTION) via which a user may create their own anomaly detection objects using native syntax of the database. For example, the user may input the command “CREATE ANOMALY_DETECTION my_ad_model (input parameters)” to create an anomaly detection object 127 named “my_ad_model” that includes an instance of the forecasting model 150 that is trained using training input time series data referenced by the input parameters specified by the user, as well as instances of the preprocessing module 125, the features module 130, the target transform module 140 and the anomaly detection function 160. When the user issues the above command, the database functionality 210A may call a training function to train the “my_ad_model” instance of the forecasting model 150 based on the training input time series data referenced by the input parameters specified by the user. The database functionality 210A may persist the trained instance of the forecasting model 150, as well as instances of the preprocessing module 125, the features module 130, the target transform module 140 and the anomaly detection function 160 as an anomaly detection object 127 named “my_ad_model” in storage associated with the user's database account, and bootstrap any states/helper functions inside the anomaly detection object 127 as needed.

As can be seen above, the command/syntax used to create the anomaly detection object may include “input parameters” regarding the training input time series data the user wishes to train the forecasting model 150 on. The input parameters may include a reference to the training input time series data itself which may include a table, a view or a query reference. The input parameters may also include a name of the timestamp column in the training input time series data and a name of the target column in the training input time series data that the user wishes to detect anomalies on. If the user wishes to train the forecasting model 150 on multiple series of the training input time series data, they may specify the series column name they wish to detect anomalies on in the input parameters.

The database functionality 210A may obtain the training input time series data referenced in the command and use the training input time series data and the input parameters to train an instance of the forecasting model 150 to generate forecasts, as discussed in further detail herein. The database functionality 210A may persist the trained forecasting model 150 instance, and instances of the preprocessing module 125, the features module 130, the target transform module 140, and the anomaly detection function 160 as an anomaly detection object 127 in storage associated with the user's database account. When the user wishes to detect anomalies on a new time series data set, they may call the anomaly detection object 127 using a command such as “CALL my_ad_model!detect_anomalies(input_data, timestamp_columnname, target_columnname, prediction_interval: 0.95).” As can be seen, the command references the anomaly detection object 127 (my_ad_model), the input time series data to be analyzed (input_data), the name of the timestamp column (timestamp_columnname) of the input time series data, and the target column (target_columnname) in the input time series data the user wishes to detect anomalies in.

The command may also specify a prediction interval (prediction_interval). A prediction interval is an estimated range of values within an upper bound and a lower bound in which a certain percentage of data is likely to fall. For example, a 0.99 prediction interval value means that 99% of the data likely appears within the interval. The anomaly detection function 160 may classify as an anomaly any data that falls outside of the prediction interval. The prediction interval may be a value between 0 and 1 and may be thought of as an indication of how strict the anomaly detection function 160 may be when classifying anomalies. A lower prediction interval value may indicate that a lower percentage of the input time series data likely appears within the interval, and thus the anomaly detection function 160 will detect more anomalies. A higher value may indicate that a higher percentage of the input time series data likely appears within the interval, and thus the anomaly detection function 160 will detect less anomalies. The stateful approach allows the anomaly detection function 160 to detect anomalies in real time as new time series data is received.

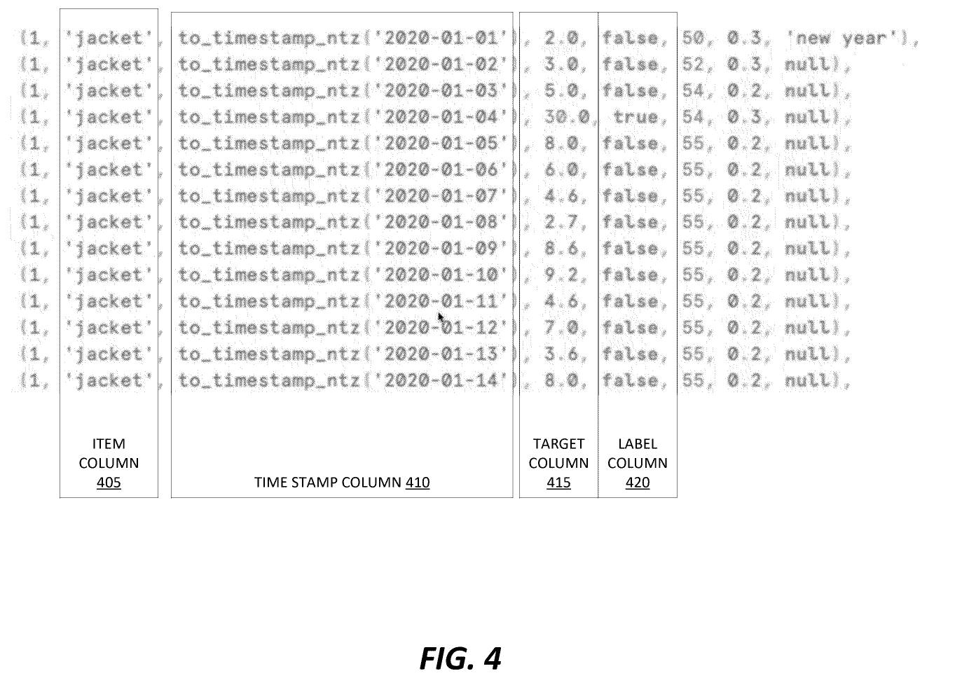

An instance of the forecasting model 150 may be trained using training input time series data comprising time series data labeled with anomalies. FIG. 4 illustrates example training input time series data representing the sales of jackets over time. As shown in FIG. 4, the data includes an item column 405, indicating the type of item sold (jacket), a timestamp column 410 indicating the days on which the jackets were sold, a target column 415 indicating the number of jackets sold on each corresponding day (the column in which the user wishes to detect anomalies), and a label column indicating whether the number of jackets sold on each day was an anomaly.

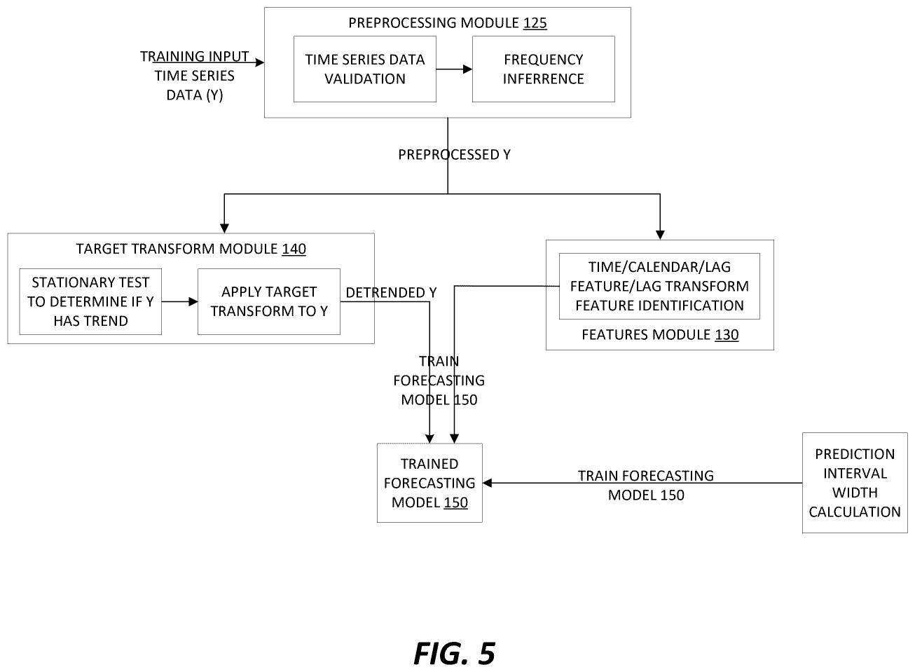

When the user runs the “CREATE ANOMALY_DETECTION” command, they specify input parameters referring to the training input time series data they wish to train the forecasting model 150 on, as well as a timestamp column of the training input time series data, so that a timestamp value for each row of the training input time series data is available as discussed herein. FIG. 5 illustrates the training process for a forecasting model 150 instance.

The preprocessing module 125 may determine whether the training input time series data, including data within the timestamp column 410, is within a supported range (e.g., 1678-01-01 00:00:00 through 2261-12-31 23:59:59), and ensure that exogenous features do not change types (e.g. if a “state_name” exogenous feature was initially encoded with string values such as “CA,” “OR,” or “NY,” and then later had an inappropriate type such as 1.0, the preprocessing module 125 would generate produce an error message). The preprocessing module 125 may also infer the sampling frequency of the training input time series from the timestamps in timestamp column 410. More specifically, if the training input time series data is regularly sampled by a recognizable sampling frequency, the preprocessing module 125 may detect the sampling frequency using any appropriate method. If a regular sampling frequency does not exist, due to missing data or irregular sampling, the preprocessing module 125 will attempt to coalesce the training input time series data into a regularly sampled time series, or produce an error message if there is not enough information.

In some embodiments, the preprocessing module 125 may infer the sampling frequency of the training input time series data using the following example method. The preprocessing module 125 may determine the top X most commonly observed time differences between the sorted timestamp inputs. The preprocessing module 125 may then cycle through collections of commonly recognized “base” sampling frequencies ranging from regular time lengths (e.g. minutely, hourly, daily), to regularly used calendar-based frequencies (yearly/monthly/weekly using the first/last day of the period, or the first/last business day of the period) as candidate sampling frequencies. The preprocessing module 125 may calculate the ratios of the determined X most common time differences with each candidate sampling frequency, and round those ratios to the nearest positive integers to generate candidate multiples.

For each candidate multiple and its corresponding candidate sampling frequency (e.g. every 3 days, every 12 minutes, every 2 business day, every 1 second), the preprocessing module 125 may compute a candidate series of timestamp values and evaluate how closely this candidate series of timestamp values matches the timestamp inputs in the training input time series data. Any appropriate matching method may be used. For example, the preprocessing module 125 may match using the Jaccard Index, or use some generalized measure of distance between two sets of timestamps. The preprocessing module 125 may select as the sampling frequency, the candidate sampling frequency whose corresponding candidate series of timestamp values best matches the timestamp inputs in the training input time series data, so long as the evaluation metrics meet a product-specified threshold (e.g., using a Jaccard Index of 0.5). The preprocessing module 125 may provide the validated training input time series data and the inferred sampling frequency to the target transform module 140 and the features module 130.

While the forecasting model 150 is capable of interpolation, depending on the type of model used it may not be able to perform extrapolation. This means the forecasting model 150 may perform poorly when input time series data has a trend depending on the type of model used to implement the forecasting model 150. Thus, in some embodiments the target transform module 140 may learn and apply one or more stabilizing transformations to the training input time series data. The target transform module 140 may initially detect whether the training input time series data has a trend or not. To do this, the target transform module 140 may first determine whether the training input time series data is stationary. A stationary time series is one whose properties do not depend on the time at which the series is observed. Thus, time series data with trends or with seasonality are not stationary because the trend and seasonality will affect the value of the time series data at different times. The target transform module 140 may determine whether the training input time series data is stationary (i.e., whether it has a trend or not) using any appropriate method.

If the training input time series data is classified as having a trend, the target transform module 140 may apply a target transform (such as a differencing transform, for example) to the input time series data to remove the trend features. While transformations such as logarithms can help to stabilize the variance of time series data, the target transform may be any appropriate transformation that helps stabilize the mean of time series data by removing changes in the level of time series data, and therefore eliminating (or reducing) trend and seasonality. In some embodiments, a window-based differencing transformation may be used to induce time series stationarity. Such a window-based differencing transformation may involve computing the difference between observations of consecutive windows and can be parameterized by a window length integer n, a window lag integer k and an aggregation function f, where f might be the mean or median function.

The features module 130 may use the timestamps included in the training input time series data to construct a variety of time/calendar features. Because time series data is often required to have a fixed sampling frequency (e.g., hourly, first of the month, etc.), the features module 130 also knows the timestamp values for arbitrary forecast horizons. Thus, the features module 130 may generate a variety of time/calendar features including:
Day (the day of the month, possible values 1-31)
Day of quarter (possible values 1-92)
Day of week (possible values 1-7)
Day of year (possible values 1-366)
Epoch Time (seconds since 1970-01-01T00:00:00Z)
Hour (hour of day, possible values 1-24)
Minute (minute of hour, possible values 1-60)
Month (month of year, possible values 1-12)
Quarter (quarter of year, possible values 1-4)
Second (second of minute, possible values 1-60)
Week of month (possible values 1-5)
Week of year (possible values 1-52)

The Epoch time feature is incremental, and is used to better fit input time series data. However, Epoch time may cause the features module 130 to overfit to the last observations of the input data. This is particularly problematic when the last point in the input time series data is an outlier. To reduce the effect of this last point, the features module 130 may flatten out the Epoch time of the last X points of input time series data, where X is any appropriate number e.g., 30. In other words, the Epoch time of the most recent data points will be flattened to be the same, so that the features module 130 is not significantly affected by the outlier effect from the last point. Although discussed with respect to flattening, this is for example only and any appropriate technique may be used to ensure that the features module 130 is not significantly affected by the outlier effect from the last point.

For each of the other features listed above, the features module 130 may generate it if: i) the base sampling frequency is equal to or below the frequency of the features, and ii) the span of the input time series data covers at least two distinct values of the date features. For example, if input time series data is sampled every two hours, the features module 130 may generate the “Month” and “Hour” features (among others), but not the “Minute” feature. In addition, the features module 130 would only generate the “Month” feature if it can construct it with at least two distinct values, meaning the input time series data in question would need to include at least two months of data.

The features module 130 may also determine lagged features for each entry of input time series data. Lagged features are features that are created by shifting the original input time series data by k time steps, where k has a value of one or more. For example, using a daily time series of sales, the features module 130 may create a lagged feature for each day of sales that is the sales of the previous day, or the sales of the same day last week, or the sales of the same day last year. In another example, if input time series data was (1, 1, 2, 3, 5, 8, 13, 21, . . . ), a lag-3 feature for the entry “8” would have values (2, 3, 5, 8, 13, 21, . . . ). Lagged features allow the forecasting model 150 to capture the patterns, trends, and seasonality within input time series data, as well as the effects of external factors or events. Lagged features can improve the accuracy and performance of the forecasting model 150 by capturing temporal dependencies and patterns in data, or enhancing the interpretability and explainability of models by revealing causal relationships and effects of past values on current values.

It should be noted that the first k observations for a lag-k feature are necessarily missing. For instance, if input time series data was (1, 1, 2, 3, 5, 8, 13, 21, . . . ), a lag-3 feature would have values (NA, NA, NA, 1, 1, 2, 3, 5, . . . ). While constructing lag features on the training data is relatively easy, populating lag features for forecasts is more challenging. For a lag-k feature, actual endogenous values are available only for the first k-horizons of a forecast, but not for horizons k+1 or larger. For these later forecasts, the forecasting model 150 may substitute the earlier forecasts in place of the actual forecasts, and proceed recursively.

The features module 130 may also determine lag transform features for each entry of input time series data. Like lagged features, lag transform features can also help capture the patterns, trends, and seasonality in the input time series data, as well as the effects of external factors or events. Lag transforms apply aggregation functions on moving window operations. An example of a lag transform feature is a 7-day rolling mean (aggregation function), averaging values over the week prior to a preset prediction window. The features module 130 may use any appropriate aggregation function such as rolling-mean or exponentially-weighted-mean. The preset prediction window is parameterized by a lag k and a length w. To produce a feature value at time t, the features module 130 may take input time series data values from times t-k-w through t-k (for a total of w values) and pass them all into the window function. Similar to lag features, lag transform features are missing for their first k+w values, and must (at least partially) forecast recursively past the kth horizon.

The features module 130 may select the lag length k and window length w parameters for lagged features and lag transform features in any appropriate manner. In some embodiments, the features module 130 may use a simple heuristic hardcoded lookup table of “standard lag length” given the input frequency. For example, the lookup table may have standard lag lengths for the following base frequencies:
Yearly
Quarterly
Monthly
Semi-Monthly
Weekly
Daily
Hourly
Minutely
Secondly

The features module 130 may use the standard lag length of the base frequency divided by the greatest common divisor (GCD) of the standard length and the multiple of the base frequency when the frequency of the training input time series data is a multiple of a base frequency. For instance, if input time series data is sampled every two hours, the features module 130 may use a standard lag length of 24/GCD (24, 2)=24/2=12. If input time series data is sampled every five hours, the features module 130 may use a standard lag length of 24/GCD (24, 5)=24/1=24. All lag features and lag transform features may use a multiple of this standard length for k and window lengths may be set to 2*k.

There is a tension between including more lag and lag transform features, and adding missing values to the first several rows of training input time series data. While the forecasting model 150 can be trained on rows with partial missing values, this may harm the performance relative to dropping these rows, at least with respect to lag and lag transform features. Relatedly, additional missing values may be induced whenever a target transformation is applied or when constructing conformal prediction intervals (as discussed in further detail herein).

For these reasons, during training of the forecasting model 150, including features must be balanced against reducing the size of the training input time series data. In some embodiments, the training function may use a heuristically selected set of constants to control the number of lag and lag-transforms features based on the number of endogenous observations included within the training input time series data.

Once the features module 130 has determined the features that will be used to train the forecasting model 150, the training function may use the determined features (and the detrended training input time series data if applicable) to train the forecasting model 150 using any well-known machine learning model training technique. In some embodiments, the training function may use the mean absolute error (MAE) metric to train the forecasting model 150. MAE is a commonly used metric for measuring the accuracy of forecast models by quantifying the average magnitude of errors in a set of predictions. MAE is calculated by taking the absolute difference between the actual values and the predicted values, and then averaging these differences.

While some embodiments utilize ML models that are probabilistic and thus have built in prediction interval construction, not all ML models are probabilistic in nature, and therefore the ML models used in some embodiments do not generate prediction intervals. In such embodiments, the training function may train the forecasting model 150 to use conformal methods to generate upper and lower bounds for (i.e., the width of) the prediction interval from out-of-sample residuals.

In one example, before training the forecast model 150 on the entire training input time series data, the training function may train one or more versions of the forecast model 150 on subsets of the training input time series data, where the last tail of the training input time series data is reserved as holdout data. Then, each version of the forecast model 150 may generate a prediction based on the holdout data using a fixed horizon length, where the horizon length is heuristically determined using the total number of observations. Each predicted value may be matched with a corresponding actual value from the holdout dataset, and a set of “conformal” squared residuals may be generated, indexed by the forecast horizon and the holdout dataset. From this set of residuals, the training function may fit an ML model (not shown) to estimate the prediction interval width. One example of such a model could be a linear regression (LR) model, with a single slope term on the forecast horizon, using the squared residuals as targets. This ML model can be used to predict the variance at a specific forecast horizon given an appropriately chosen probabilistic distribution (e.g. Gaussian). The training function may enforce non-negative constraints on the slope and intercept of the ML model to prevent extrapolation to non-negative variances.

Given a probability distribution, derived from the forecasting model 150 or via conformal methods, the lower bound and upper bound of the prediction interval, per forecasted timestamp, may be generated using the user provided prediction interval argument, which is the percentile of the prediction interval as discussed hereinabove.

Once trained, the database functionality 210A may persist the trained forecasting model 150 instance within an anomaly detection object 127 (as discussed above) for future usage, such as online monitoring.

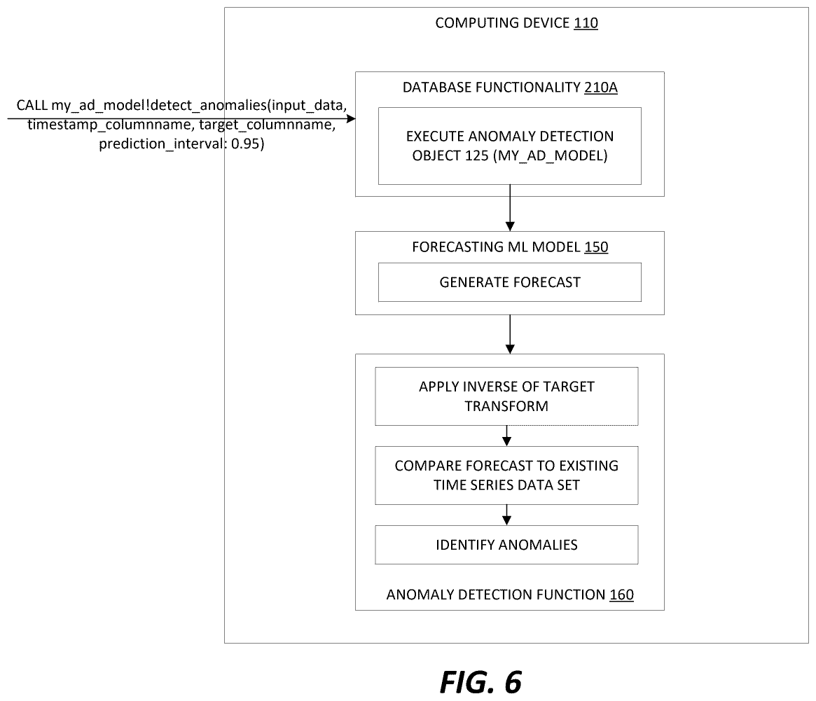

Subsequently, the user may wish to detect anomalies on an existing time series data set. Referring also to FIG. 6, the user may issue a call to the anomaly detection object 127 and specify the time series data they wish to detect anomalies in and other input parameters of relevance (as discussed hereinabove). The target transform module 140 may detrend the time series data as necessary, and the features module 130 may detect features from the time series data as discussed hereinabove. The trained forecasting model 150 may use the detected features and the detrended time series data to generate a forecast for the same time period as the existing time series data set and provide the forecast and the calculated prediction interval width information to the anomaly detection function 160. The anomaly detection function 160 may apply to the forecast generated by the forecasting model 150, an inverse of the target transformation applied to the input time series data by the target transform module 140. For example, the anomaly detection function 160 may apply the target transformation applied by the target transform module 140 in reverse order to the forecast generated by the forecasting model 150. The anomaly detection function 160 may then compare the existing time series data set to the forecast to identify outliers using the calculated prediction interval width information. The anomaly detection function 160 may label each individual row in the specified target column(s) of the existing time series data set as anomalous or not anomalous. In some embodiments, the anomaly detection function 160 may include an alert function to provide alerts to the user when anomalies are detected. In other embodiments, the database functionality 210A may include an alert function (not shown) that can be leveraged by the anomaly detection function 160 to issue alerts to the user when anomalies are detected.

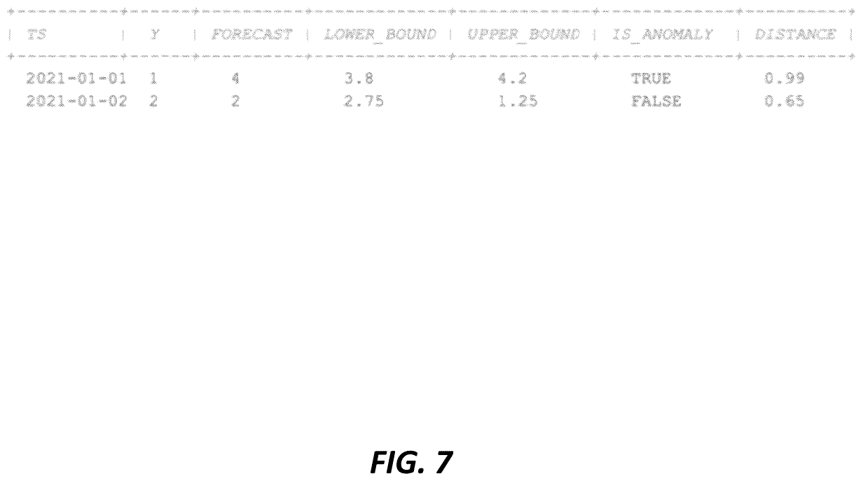

FIG. 7 illustrates an example output of the anomaly detection function 160, in accordance with some embodiments of the present disclosure. As can be seen, for each time stamp, the anomaly detection function 160 may indicate the actual value, the forecasted value, the upper and lower bound of the prediction interval, and an indication of whether the actual value is an anomaly.

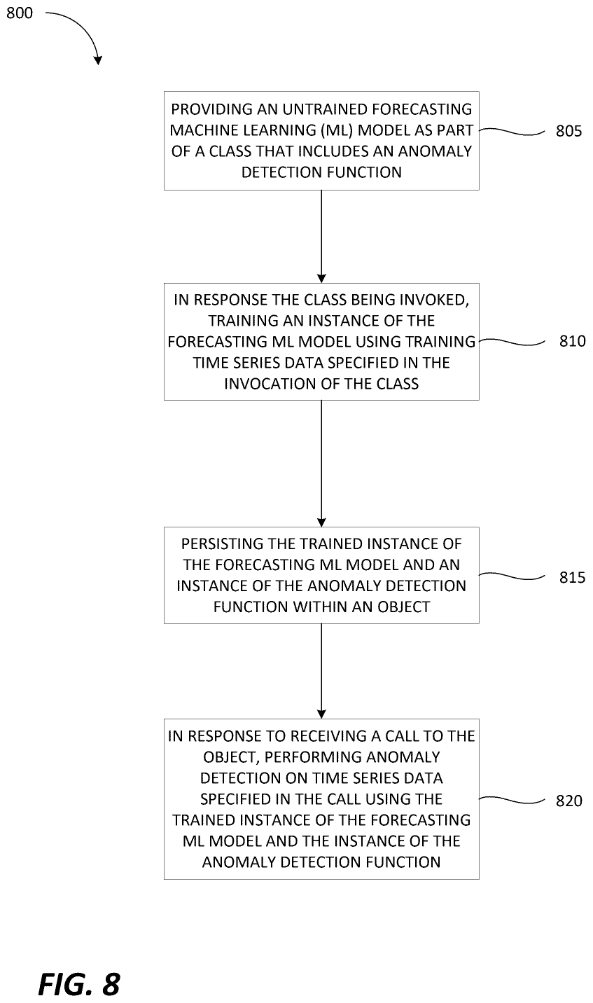

FIG. 8 is a flow diagram of a method 800 of detecting anomalies in time series data using an ML model, in accordance with some embodiments of the present disclosure. Method 800 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 800 may be performed by a computing device (e.g., computing device 110 executing the anomaly detection module 120A as illustrated in FIG. 2).

Referring also to FIG. 3, at block 805 the database functionality 210A may provide the anomaly detection module 120A as a class (referred to as e.g., ANOMALY_DETECTION) via which a user may create their own anomaly detection objects using native syntax of the database. For example, at block 810 the user may input the command “CREATE ANOMALY_DETECTION my_ad_model (input parameters)” to create an anomaly detection object 127 named “my_ad_model” that includes an instance of the forecasting model 150 that is trained using training input time series data referenced by the input parameters specified by the user, as well as instances of the preprocessing module 125, the features module 130, the target transform module 140, and the anomaly detection function 160. When the user issues the above command, the database functionality 210A may call a training function to train the “my_ad_model” instance of the forecasting model 150 based on the training input time series data referenced by the input parameters specified by the user.

As can be seen above, the command/syntax used to create the anomaly detection object may include “input parameters” regarding the training input time series data the user wishes to train the forecasting model 150 on. The input parameters may include a reference to the training input time series data itself which may include a table, a view or a query reference. The input parameters may also include a name of the time stamp column in the training input time series data and a name of the target column in the training input time series data that the user wishes to detect anomalies on. If the user wishes to train the forecasting model 150 on multiple series of the training input time series data, they may specify the series column name they wish to detect anomalies on in the input parameters.

FIG. 5 illustrates the training process for a forecasting model 150 instance. The preprocessing module 125 may determine whether the training input time series data, including data within the timestamp column 410, is within a supported range (e.g., 1678-01-01 00:00:00 through 2261-12-31 23:59:59), and ensure that exogenous features do not change types (e.g. if a “state_name” exogenous feature was initially encoded with string values such as “CA,” “OR,” or “NY,” and then later had an inappropriate type such as 1.0, the preprocessing module 125 would generate produce an error message). The preprocessing module 125 may also infer the sampling frequency of the training input time series from the timestamps in timestamp column 410. More specifically, if the training input time series data is regularly sampled by a recognizable sampling frequency, the preprocessing module 125 may detect the sampling frequency using any appropriate method. If a regular sampling frequency does not exist, due to missing data or irregular sampling, the preprocessing module 125 will attempt to coalesce the training input time series data into a regularly sampled time series, or produce an error message if there is not enough information.

In some embodiments, the preprocessing module 125 may infer the sampling frequency of the training input time series data using the following example method. The preprocessing module 125 may determine the top X most commonly observed time differences between the sorted timestamp inputs. The preprocessing module 125 may then cycle through collections of commonly recognized “base” sampling frequencies ranging from regular time lengths (e.g. minutely, hourly, daily), to regularly used calendar-based frequencies (yearly/monthly/weekly using the first/last day of the period, or the first/last business day of the period) as candidate sampling frequencies. The preprocessing module 125 may calculate the ratios of the determined X most common time differences with each candidate sampling frequency, and round those ratios to the nearest positive integers to generate candidate multiples.

For each candidate multiple and its corresponding candidate sampling frequency (e.g. every 3 days, every 12 minutes, every 2 business day, every 1 second), the preprocessing module 125 may compute a candidate series of timestamp values and evaluate how closely this candidate series of timestamp values matches the timestamp inputs in the training input time series data. Any appropriate matching method may be used. For example, the preprocessing module 125 may match using the Jaccard Index, or use some generalized measure of distance between two sets of timestamps. The preprocessing module 125 may select as the sampling frequency, the candidate sampling frequency whose corresponding candidate series of timestamp values best matches the timestamp inputs in the training input time series data, so long as the evaluation metrics meet a product-specified threshold (e.g., using a Jaccard Index of 0.5). The preprocessing module 125 may provide the validated training input time series data and the inferred sampling frequency to the target transform module 140 and the features module 130.

While the forecasting model 150 is capable of interpolation, depending on the type of model used it may not be able to perform extrapolation. This means the forecasting model 150 may perform poorly when input time series data has a trend. Thus, in some embodiments the target transform module 140 may learn and apply one or more stabilizing transformations to the training input time series data. The target transform module 140 may initially detect whether the training input time series data has a trend or not. To do this, the target transform module 140 may first determine whether the training input time series data is stationary. A stationary time series is one whose properties do not depend on the time at which the series is observed. Thus, time series data with trends or with seasonality are not stationary because the trend and seasonality will affect the value of the time series data at different times. The target transform module 140 may determine whether the training input time series data is stationary (i.e., whether it has a trend or not) using any appropriate method.

If the training input time series data is classified as having a trend, the target transform module 140 may apply a target transform (such as a differencing transform, for example) to the input time series data to remove the trend features. While transformations such as logarithms can help to stabilize the variance of time series data, the target transform may be any appropriate transformation that helps stabilize the mean of time series data by removing changes in the level of time series data, and therefore eliminating (or reducing) trend and seasonality. In some embodiments, a window-based differencing transformation may be used to induce time series stationarity. Such a window-based differencing transformation may involve computing the difference between observations of consecutive windows and can be parameterized by a window length integer n, a window lag integer k and an aggregation function f, where f might be the mean or median function.

The features module 130 may use the timestamps included in the training input time series data to construct a variety of time/calendar features. Because time series data is often required to have a fixed sampling frequency (e.g., hourly, first of the month, etc.), the features module 130 also knows the timestamp values for arbitrary forecast horizons. Thus, the features module 130 may generate a variety of time/calendar features including:
Day (the day of the month, possible values 1-31)·
Day of quarter (possible values 1-92)·
Day of week (possible values 1-7)
Day of year (possible values 1-366)·
Epoch Time (seconds since 1970-01-01T00:00:00Z)·
Hour (hour of day, possible values 1-24)·
Minute (minute of hour, possible values 1-60)·
Month (month of year, possible values 1-12)·
Quarter (quarter of year, possible values 1-4)·
Second (second of minute, possible values 1-60)·
Week of month (possible values 1-5)·
Week of year (possible values 1-52)

The Epoch time feature is incremental, and is used to better fit input time series data. However, Epoch time may cause the features module 130 to overfit to the last observations of the input data. This is particularly problematic when the last point in the input time series data is an outlier. To reduce the effect of this last point, the features module 130 may flatten out the Epoch time of the last X points of input time series data, where X is any appropriate number e.g., 30. In other words, the Epoch time of the most recent data points will be flattened to be the same, so that the features module 130 is not significantly affected by the outlier effect from the last point. Although discussed with respect to flattening, this is for example only and any appropriate technique may be used to ensure that the features module 130 is not significantly affected by the outlier effect from the last point.

For each of the other features listed above, the features module 130 may generate it if: i) the base sampling frequency is equal to or below the frequency of the features, and ii) the span of the input time series data covers at least two distinct values of the date features. For example, if input time series data is sampled every two hours, the features module 130 may generate the “Month” and “Hour” features (among others), but not the “Minute” feature. In addition, the features module 130 would only generate the “Month” feature if it can construct it with at least two distinct values, meaning the input time series data in question would need to include at least two months of data.

The features module 130 may also determine lagged features for each entry of input time series data. Lagged features are features that are created by shifting the original input time series data by k time steps, where k has a value of one or more. For example, using a daily time series of sales, the features module 130 may create a lagged feature for each day of sales that is the sales of the previous day, or the sales of the same day last week, or the sales of the same day last year. In another example, if input time series data was (1, 1, 2, 3, 5, 8, 13, 21, . . . ), a lag-3 feature for the entry “8” would have values (2, 3, 5, 8, 13, 21, . . . ). Lagged features allow the forecasting model 150 to capture the patterns, trends, and seasonality within input time series data, as well as the effects of external factors or events. Lagged features can improve the accuracy and performance of the forecasting model 150 by capturing temporal dependencies and patterns in data, or enhancing the interpretability and explainability of models by revealing causal relationships and effects of past values on current values.

It should be noted that the first k observations for a lag-k feature are necessarily missing. For instance, if input time series data was (1, 1, 2, 3, 5, 8, 13, 21, . . . ), a lag-3 feature would have values (NA, NA, NA, 1, 1, 2, 3, 5, . . . ). While constructing lag features on the training data is relatively easy, populating lag features for forecasts is more challenging. For a lag-k feature, actual endogenous values are available only for the first k-horizons of a forecast, but not for horizons k+1 or larger. For these later forecasts, the forecasting model 150 may substitute the earlier forecasts in place of the actual forecasts, and proceed recursively.

The features module 130 may also determine lag transform features for each entry of input time series data. Like lagged features, lag transform features can also help capture the patterns, trends, and seasonality in the input time series data, as well as the effects of external factors or events. Lag transforms apply aggregation functions on moving window operations. An example of a lag transform feature is a 7-day rolling mean (aggregation function), averaging values over the week prior to a preset prediction window. The features module 130 may use any appropriate aggregation function such as rolling-mean or exponentially-weighted-mean. The preset prediction window is parameterized by a lag k and a length w. To produce a feature value at time t, the features module 130 may take input time series data values from times t-k-w through t-k (for a total of w values) and pass them all into the window function. Similar to lag features, lag transform features are missing for their first k+w values, and must (at least partially) forecast recursively past the kth horizon.

The features module 130 may select the lag length k and window length w parameters for lagged features and lag transform features in any appropriate manner. In some embodiments, the features module 130 may use a simple heuristic hardcoded lookup table of “standard lag length” given the input frequency. For example, the lookup table may have standard lag lengths for the following base frequencies:
Yearly
Quarterly
Monthly
Semi-Monthly
Weekly
Daily
Hourly
Minutely
Secondly

The features module 130 may use the standard lag length of the base frequency divided by the greatest common divisor (GCD) of the standard length and the multiple of the base frequency when the frequency of the training input time series data is a multiple of a base frequency. For instance, if input time series data is sampled every two hours, the features module 130 may use a standard lag length of 24/GCD (24, 2)=24/2=12. If input time series data is sampled every five hours, the features module 130 may use a standard lag length of 24/GCD (24, 5)=24/1=24. All lag features and lag transform features may use a multiple of this standard length for k and window lengths may be set to 2*k.

There is a tension between including more lag and lag transform features, and adding missing values to the first several rows of training input time series data. While the forecasting model 150 can be trained on rows with partial missing values, this may harm the performance relative to dropping these rows, at least with respect to lag and lag transform features. Relatedly, additional missing values are induced whenever a differencing transformation is applied or when constructing conformal prediction intervals (as discussed in further detail herein).

For these reasons, during training of the forecasting model 150, including features must be balanced against reducing the size of the training input time series data. In some embodiments, the training function may use a heuristically selected set of constants to control the number of lag and lag-transforms features based on the number of endogenous observations included within the training input time series data.

Once the features module 130 has determined the features that will be used to train the forecasting model 150, the training function may use the determined features (and the detrended training input time series data if applicable) to train the forecasting model 150 using any well-known machine learning model training technique. In some embodiments, the training function may use the mean absolute error (MAE) metric to train the forecasting model 150. MAE is a commonly used metric for measuring the accuracy of forecast models by quantifying the average magnitude of errors in a set of predictions. MAE is calculated by taking the absolute difference between the actual values and the predicted values, and then averaging these differences.

While some embodiments utilize ML models that are probabilistic and thus have built in prediction interval construction, not all ML models are probabilistic in nature, and therefore the ML models used in some embodiments do not generate prediction intervals. In such embodiments, the training function may train the forecasting model 150 to use conformal methods to generate upper and lower bounds for (i.e., the width of) the prediction interval from out-of-sample residuals.

In one example, before training the forecast model 150 on the entire training input time series data, the training function may train one or more versions of the forecast model 150 on subsets of the training input time series data, where the last tail of the training input time series data is reserved as holdout data. Then, each version of the forecast model 150 may generate a prediction based on the holdout data using a fixed horizon length, where the horizon length is heuristically determined using the total number of observations. Each predicted value may be matched with a corresponding actual value from the holdout dataset, and a set of “conformal” squared residuals may be generated, indexed by the forecast horizon and the holdout dataset. From this set of residuals, the training function may fit an ML model (not shown) to estimate the prediction interval width. One example of such a model could be a linear regression (LR) model, with a single slope term on the forecast horizon, using the squared residuals as targets. This ML model can be used to predict the variance at a specific forecast horizon given an appropriately chosen probabilistic distribution (e.g. Gaussian). The training function may enforce non-negative constraints on the slope and intercept of the ML model to prevent extrapolation to non-negative variances.

Given a probability distribution, derived from the forecasting model 150 or via conformal methods, the lower bound and upper bound of the prediction interval, per forecasted timestamp, may be generated using the user provided prediction interval argument, which is the percentile of the prediction interval as discussed hereinabove.

Once trained, at block 815 the database functionality 210A may persist the trained forecasting model 150 instance within an anomaly detection object 127 (as discussed above) for future usage, such as online monitoring.

Subsequently, the user may wish to detect anomalies on an existing time series data set. Referring also to FIG. 6, at block 820 the user may issue a call to the anomaly detection object 127 and specify the time series data they wish to detect anomalies in and other input parameters of relevance (as discussed hereinabove). The target transform module 140 may detrend the time series data as necessary, and the features module 130 may detect features from the time series data as discussed hereinabove. The trained forecasting model 150 may use the detected features and the detrended time series data to generate a forecast for the same time period as the existing time series data set and provide the forecast and the calculated prediction interval width information to the anomaly detection function 160. The anomaly detection function 160 may apply to the forecast generated by the forecasting model 150, an inverse of the target transformation applied to the input time series data by the target transform module 140. For example, the anomaly detection function 160 may apply the target transformation applied by the target transform module 140 in reverse order to the forecast generated by the forecasting model 150. The anomaly detection function 160 which may then compare the existing time series data set to the generated forecast to identify outliers using the calculated prediction interval width information. The anomaly detection function 160 may label each individual row in the specified target column(s) of the existing time series data set as anomalous or not anomalous. In some embodiments, the anomaly detection function 160 may include an alert function to provide alerts to the user when anomalies are detected. In other embodiments, the database functionality 210A may include an alert function (not shown) that can be leveraged by the anomaly detection function 160 to issue alerts to the user when anomalies are detected.

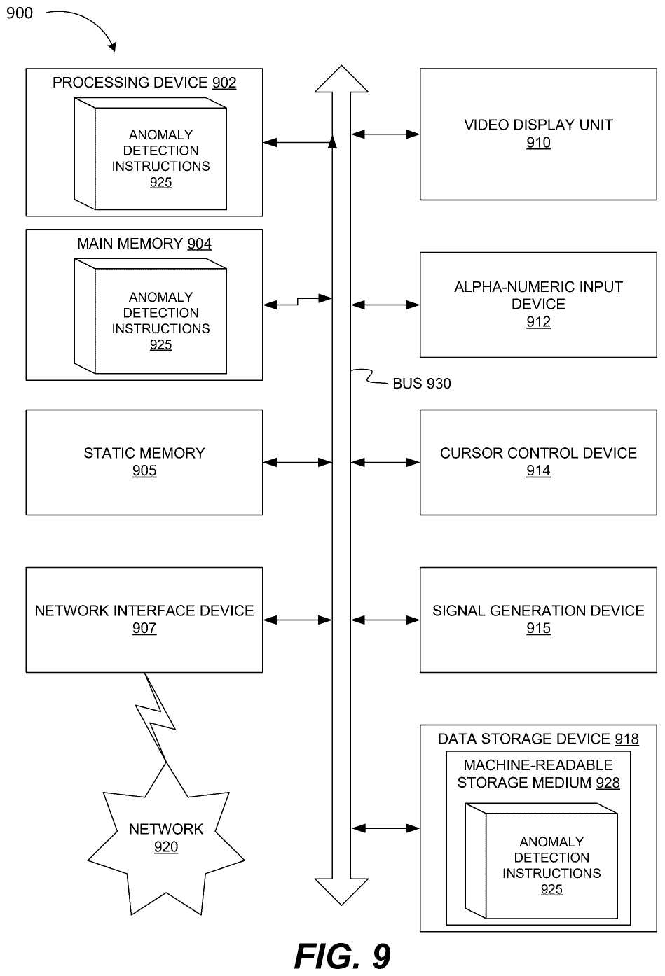

FIG. 9 illustrates a diagrammatic representation of a machine in the example form of a computer system 900 within which a set of instructions, for causing the machine to perform any one or more of the methodologies discussed herein for detecting anomalies in time series data using an ML model.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 900 may be representative of a server.

The exemplary computer system 900 includes a processing device 902, a main memory 904 (e.g., read-only memory (ROM), flash memory, dynamic random access memory (DRAM)), a static memory 905 (e.g., flash memory, static random access memory (SRAM), etc.), and a data storage device 918, which communicate with each other via a bus 930. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 900 may further include a network interface device 907 which may communicate with a network 920. The computing device 900 also may include a video display unit 910 (e.g., a liquid crystal display (LCD) or a cathode ray tube (CRT)), an alphanumeric input device 912 (e.g., a keyboard), a cursor control device 914 (e.g., a mouse) and an acoustic signal generation device 915 (e.g., a speaker). In one embodiment, video display unit 910, alphanumeric input device 912, and cursor control device 914 may be combined into a single component or device (e.g., an LCD touch screen).

Processing device 902 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 is configured to execute anomaly detection instructions 925, for performing the operations and steps discussed herein.

The data storage device 918 may include a machine-readable storage medium 928, on which is stored one or more sets of anomaly detection instructions 925 (e.g., software) embodying any one or more of the methodologies of functions described herein. The anomaly detection instructions 925 may also reside, completely or at least partially, within the main memory 904 or within the processing device 902 during execution thereof by the computer system 900; the main memory 904 and the processing device 902 also constituting machine-readable storage media. The anomaly detection instructions 925 may further be transmitted or received over a network 920 via the network interface device 907.

The machine-readable storage medium 928 may also be used to store instructions to perform a method for specifying a stream processing topology (dynamically creating topics, interacting with these topics, merging the topics, reading from the topics, and obtaining dynamic insights therefrom) via a client-side API without server-side support, as described herein. While the machine-readable storage medium 928 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
providing an untrained forecasting machine learning (ML) model as part of a class that includes an anomaly detection function;
in response the class being invoked, training an instance of the forecasting ML model using training time series data specified in the invocation of the class;
persisting the trained instance of the forecasting ML model and an instance of the anomaly detection function within an object; and
in response to receiving a call to the object, performing anomaly detection on time series data specified in the call using the trained instance of the forecasting ML model and the instance of the anomaly detection function.

2. The method of claim 1, wherein training the instance of the forecasting ML model comprises:
determining, using a target transform module of the class, whether the training time series data has a trend;
in response to determining that the training time series data has a trend, applying, using the target transform module, a target transform to the training time series data to generate detrended training time series data;
determining, using a features module of the class, a set of training features based on the detrended training time series data; and
training the instance of the forecasting ML model using the set of training features.

3. The method of claim 2, wherein training the instance of the forecasting ML model further comprises:
training the instance of the forecasting ML model to calculate a prediction interval width.

4. The method of claim 2, wherein training the instance of the forecasting ML model further comprises:
validating the training time series data; and
determining a sampling frequency of the training time series data.

5. The method of claim 2, wherein an instance of the target transform module and an instance of the features module are persisted in the object along with the trained instance of the forecasting ML model and the instance of the anomaly detection function.

6. The method of claim 5, wherein performing anomaly detection on the time series data specified in the call comprises:
determining, using the instance of the target transform module, whether the time series data has a trend;
in response to determining that the time series data has a trend, applying, using the instance of the target transform module, a target transform to the time series data to generate detrended time series data;
determining, using the instance of the features module, a set of features based on the detrended time series data; and
generating, using the trained instance of the forecasting ML model, a forecast based on the detrended time series data, wherein the forecast corresponds to the same time period as the detrended time series data.

7. The method of claim 6, wherein performing anomaly detection on the time series data specified in the call further comprises:
comparing, using the instance of the anomaly detection function, the forecast to the time series data to detect one or more anomalies.

8. A system comprising:
a memory; and
a processing device operatively coupled to the memory, the processing device to:
provide an untrained forecasting machine learning (ML) model as part of a class that includes an anomaly detection function;
in response the class being invoked, train an instance of the forecasting ML model using training time series data specified in the invocation of the class;
persist the trained instance of the forecasting ML model and an instance of the anomaly detection function within an object; and
in response to receiving a call to the object, perform anomaly detection on time series data specified in the call using the trained instance of the forecasting ML model and the instance of the anomaly detection function.

9. The system of claim 8, wherein to train the instance of the forecasting ML model, the processing device is to:
determine, using a target transform module of the class, whether the training time series data has a trend;
in response to determining that the training time series data has a trend, apply, using the target transform module, a target transform to the training time series data to generate detrended training time series data;
determine, using a features module of the class, a set of training features based on the detrended training time series data; and
train the instance of the forecasting ML model using the set of training features.

10. The system of claim 9, wherein to train the instance of the forecasting ML model, the processing device is further to:
train the instance of the forecasting ML model to calculate a prediction interval width.

11. The system of claim 9, wherein to train the instance of the forecasting ML model, the processing device is further to:
validate the training time series data; and
determine a sampling frequency of the training time series data.

12. The system of claim 9, wherein the processing device persists an instance of the target transform module and an instance of the features module in the object along with the trained instance of the forecasting ML model and the instance of the anomaly detection function.

13. The system of claim 12, wherein to perform anomaly detection on the time series data specified in the call, the processing device is to:
determine, using the instance of the target transform module, whether the time series data has a trend;
in response to determining that the time series data has a trend, apply, using the instance of the target transform module, a target transform to the time series data to generate detrended time series data;
determine, using the instance of the features module, a set of features based on the detrended time series data; and
generate, using the trained instance of the forecasting ML model, a forecast based on the detrended time series data, wherein the forecast corresponds to the same time period as the detrended time series data.

14. The system of claim 13, wherein to perform the anomaly detection on the time series data specified in the call, the processing device is further to:
compare, using the instance of the anomaly detection function, the forecast to the time series data to detect one or more anomalies.

15. A non-transitory computer-readable medium having instructions stored thereon which, when executed by a processing device, cause the processing device to:
provide an untrained forecasting machine learning (ML) model as part of a class that includes an anomaly detection function;
in response the class being invoked, train an instance of the forecasting ML model using training time series data specified in the invocation of the class;
persist the trained instance of the forecasting ML model and an instance of the anomaly detection function within an object; and
in response to receiving a call to the object, perform anomaly detection on time series data specified in the call using the trained instance of the forecasting ML model and the instance of the anomaly detection function.

16. The non-transitory computer-readable medium of claim 15, wherein to train the instance of the forecasting ML model, the processing device is to:
determine, using a target transform module of the class, whether the training time series data has a trend;
in response to determining that the training time series data has a trend, apply, using the target transform module, a target transform to the training time series data to generate detrended training time series data;
determine, using a features module of the class, a set of training features based on the detrended training time series data; and
train the instance of the forecasting ML model using the set of training features.

17. The non-transitory computer-readable medium of claim 16, wherein to train the instance of the forecasting ML model, the processing device is further to:
train the instance of the forecasting ML model to calculate a prediction interval width.

18. The non-transitory computer-readable medium of claim 16, wherein to train the instance of the forecasting ML model, the processing device is further to:
validate the training time series data; and
determine a sampling frequency of the training time series data.

19. The non-transitory computer-readable medium of claim 16, wherein the processing device persists an instance of the target transform module and an instance of the features module in the object along with the trained instance of the forecasting ML model and the instance of the anomaly detection function.

20. The non-transitory computer-readable medium of claim 19, wherein to perform anomaly detection on the time series data specified in the call, the processing device is to:
determine, using the instance of the target transform module, whether the time series data has a trend;
in response to determining that the time series data has a trend, apply, using the instance of the target transform module, a target transform to the time series data to generate detrended time series data;
determine, using the instance of the features module, a set of features based on the detrended time series data; and
generate, using the trained instance of the forecasting ML model, a forecast based on the detrended time series data, wherein the forecast corresponds to the same time period as the detrended time series data.

21. The non-transitory computer-readable medium of claim 20, wherein to perform the anomaly detection on the time series data specified in the call, the processing device is further to:
compare, using the instance of the anomaly detection function, the forecast to the time series data to detect one or more anomalies.
